(19) United States
(12) Patent Application Publication
(10) Pub. No.: US 2007/0156967 A1
(43) Pub. Date: Jul. 5, 2007

(54) Identifying delinquent object chains in a managed run time environment

(76) Inventors: Michael Bond, Austin, TX (US); Shirish Aundhe, Beaverton, OR (US); Greg Eastman, Hillsboro, OR (US); Suresh Srinivas, Portland, OR (US)

Correspondence Address: TROP PRUNER & HU, PC, 1616 S. VOSS ROAD, SUITE 750, HOUSTON, TX, 77057-2631, US

(21) Appl. No.: 11/321,133

(22) Filed: Dec. 29, 2005

(51) Int. Cl. G06F 12/00

(52) U.S. Cl. 711/137

(57) ABSTRACT

In one embodiment, an object oriented programming language can pre-fetch objects and fields within those objects to a cache memory. A hardware performance monitor can be used to identify loads that read from an address that is frequently absent from a memory. Instrumentation can be used to mark the objects that include the frequently missed address. A compiler can identify chains of objects that are frequently absent from memory. The chains of objects can be pre-fetched without regard to the types of object. Other embodiments are described and claimed.

### BACKGROUND

Embodiments of the present invention relate generally to pre-fetching objects for use with an object oriented program.

An example of an object oriented programming language is Java® from Sun Microsystems Incorporated. A Java virtual machine can give Java programs a software-based computer they can interact with. Because the Java virtual machine is not a real computer but exists in software, a Java program can run on any physical computing platform, such as Windows, Macintosh, Linux, Unix or any other system equipped with a Java virtual machine.

Object-oriented programming languages use generalized categories, called classes, that describe a group of more specific items called objects. Classes can define fields that are used by objects. Objects are specific instances of a class that can include values for the fields defined by the class.

A system running a virtual machine can include cache memory, and main memory. Cache memory can be memory located on a computer's processor. A cache hit can occur when data to be read is stored in cache memory. A cache miss occurs when data to be read is not stored in cache memory.

Main memory is typically a memory located outside a processor. Storing data used by a program in cache memory prior to the data being read can increase the speed of a system in some embodiments by not having to read data from the main memory.

An object can reference another object. When an object references another object, a load can be performed to retrieve a field from an object or a group of objects. If the object cannot be located in the cache memory, the virtual machine can make an access to a computer's main memory to retrieve the object; however, this can negatively influence performance.

### BRIEF DESCRIPTION OF THE DRAWINGS

FIG. 1 is a block diagram illustrating hardware/software interaction in a system in accordance with one embodiment of the present invention.

FIG. 2 depicts a flow chart representing an embodiment of a program code.

FIG. 3 is a block diagram showing a portion of a main memory storing objects.

FIG. 4 depicts an embodiment of a computer system including a virtual machine.

FIG. 5 depicts a flow chart representing an embodiment of a process for identifying chains of delinquent objects.

FIG. 6 depicts an embodiment of an apparatus for identifying delinquent objects.

### DETAILED DESCRIPTION

A hardware performance monitor can be a circuit used to oversee the performance behavior of a system. A hardware performance monitor in some embodiments can identify a potentially small subset of delinquent objects, which are objects that are frequently missed in a cache memory.

Identifying most of the delinquent objects and chains of delinquent objects can be beneficial to the efficiency of a virtual machine. A virtual machine that can be used in an embodiment is available from BEA Systems Incorporated of San Jose, Calif.

Objects can contain multiple fields. For example, if an object A identified a person, and object B identified another person, a field within object A might include the first person's name and a field within object B might include the second person's name. A load, which is an instruction to read data from memory for use by a program, can read a field stored by an object. For example, a load of the first person's name can be referenced as A.Name, where A identifies the object of the first person and Name identifies the field in object A storing the name of the first person. For the second person, a load referenced as B.Name can read the name field of the second object. A bit can be set in the header of object A and object B as the first instance of the load is performed to identify objects A and B as delinquent objects of a delinquent load.

Delinquent loads refer to target data addresses that are frequently missed in the cache memory. A virtual machine can use many more objects than loads. A hardware performance monitor can identify most of the delinquent loads but not most of the delinquent objects because there can be fewer loads than objects.

Cache size, processor speed or frequency of use of data can be some of the variables used to determine if an address should be identified by the hardware performance monitor as frequently missed in the cache. For example, in one embodiment if an address is missed, the address is identified as frequently missed and in other embodiments an address can result in a cache miss a percentage of the time before the address is identified as frequently missed. The percentage can be determined by the hardware performance monitor, in one embodiment.

A hardware performance monitor can be used to capture instructions whose target addresses frequently miss in the cache memory. The capture may be performed during dynamic profile-guided optimization operations using a given hardware performance monitor, and more particularly using hardware of the monitor such as data event address registers (EARs). A hardware performance monitor that can be used is included with Itanium® processors available from Intel Corporation of Santa Clara, Calif.

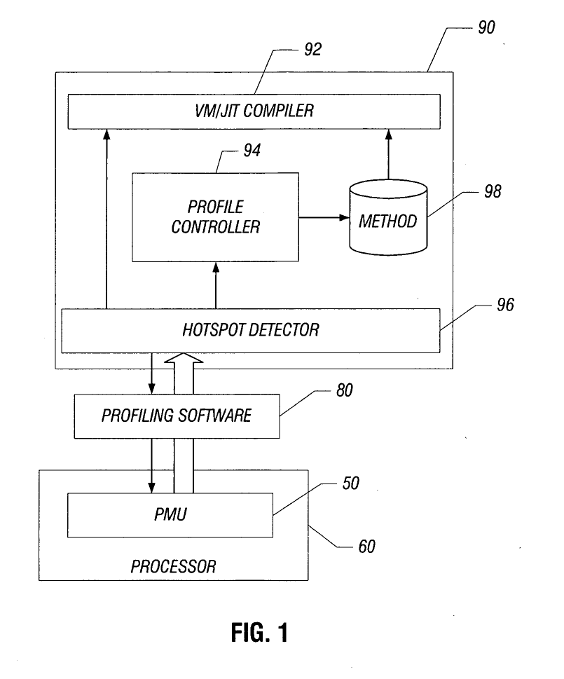

Referring now to FIG. 1, shown is a block diagram illustrating hardware/software interaction in a system in accordance with one embodiment of the present invention. As shown in FIG. 1, the hardware includes a processor 60 that has a performance monitoring unit (PMU), which may include hardware counters, registers and the like. Profiling software 80 may communicate with processor 60 to implement collection of data using PMU 50, e.g., via sampling. Thus as shown in FIG. 1, profiling software 80 sends configuration/control signals to processor 60. In turn, processor 60 performs profile activities, e.g., counting in accordance with the sampling performed by profiling software 80. When requested by profiling software 80, processor 60 may communicate profile data that in turn is provided to a dynamic profile-guided optimization (DPGO) system 90.

As shown in FIG. 1, DPGO system 90 may include a virtual machine (VM)/just-in-time (JIT) compiler 92 that may exist in a managed runtime environment (MRTE) and that may receive control and configuration information, such as a recompilation trigger, from a hot spot detector 96. Hot spot detector 96 may be coupled to a profile controller 94, which in turn generates profiles from collected data (e.g., methods sampling data) and provides it to a method buffer 98. Profile data may then be passed from method buffer 98 to VM/JIT compiler 92 for use in driving optimizations, for example, managed run time environment (MRTE) code optimizations. Thus DPGO system 90 consumes the data collected by profiling software 80 to identify optimization opportunities within the currently executing code.

A hardware performance monitor can identify addresses that are accessed and not frequently present in the cache memory. The hardware performance monitor can collect the information regarding addresses frequently not stored in the faster memory e.g., via sampling. A virtual machine can use this information obtained by from the hardware performance monitor to generate instrumentation, which can be a set of instructions or code that is inserted into a program code. The instrumentation code may mark a header of an object to identify the object as a delinquent object of a delinquent load. A header is data in an object that identifies the object. In various embodiments, a user-defined analysis may be performed by the VM to find the chains of delinquent loads.

The instrumentation code inserted in the program code can thus mark the object that contains the field identified by the address that is absent from the cache memory. In one embodiment, delinquent objects may be marked in their object headers using at least one bit, although the scope of the present invention is not so limited. One bit may be used to specify a delinquent root. When using two bits, a first bit can identify the object as delinquent or not and the second bit can identify the object as a root or a child. Since such instrumentation can be performed on all instances, most of the delinquent object chains can be captured.

In some embodiments, a Java virtual machine can pre-fetch objects based on object type. The object type can be, for example, all objects from the same class. If an object references another object outside of that type or class, the object that is being referenced can result in a cache miss because only the objects of the same type were prefetched. A Java virtual machine can also pre-fetch addresses in memory located after an address that is being fetched. Marking objects as delinquent so that a chain can be formed allows pre-fetching of an entire chain of frequently delinquent loads when the load of the first field in the chain is performed.

Pre-fetching a chain of delinquent objects can begin by a reference (i.e., a load) for an address corresponding to a root object. The root object can be the first loaded field in a chain of loaded fields. In the context of delinquent loads, this root load is the first load in a chain of delinquent loads, i.e., loads for data that are frequently absent from a cache memory. In one embodiment, the root object can be fetched along with all of the child objects via a pre-fetch operation. The pre-fetch operation can pre-fetch the child objects by using the markings in the object header of the object with the field being accessed by the load. The markings of the child objects can be added by the instrumentation. A compiler can define likely chains or trees of delinquent objects. A compiler can be used to identify child loads to create a chain of delinquent objects when the child objects are not marked by the instrumentation. A tree of delinquent objects can include branches from previous objects.

The compiler can use static analysis based on where the delinquent loads are located to determine which objects are the roots and which are the children of a chain. If the children are not marked, a static graph can be used to follow the root to the child. For example, A.Name can then give the next object, B. The chain or tree can be created by the object references instead of dependent delinquent loads because in some embodiments pre-fetching of dependent delinquent loads can pre-fetch loads that were not delinquent because they were pre-fetched with previously loaded objects sharing a cache line or non-dependent delinquent loads can still load dependent objects that share a cache line.

A root load can begin the pre-fetching of a delinquent object chain identified by the root load. The root load and the child loads can be read from memory and stored in the cache memory. Thus when a prefetch operation occurs during execution, because the object from the child load has already been pre-fetched, the virtual machine does not have to read main memory to retrieve the child object.

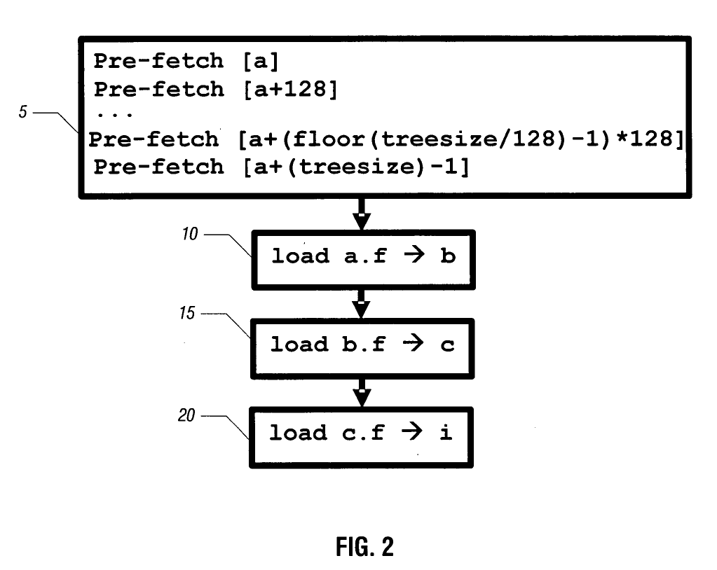

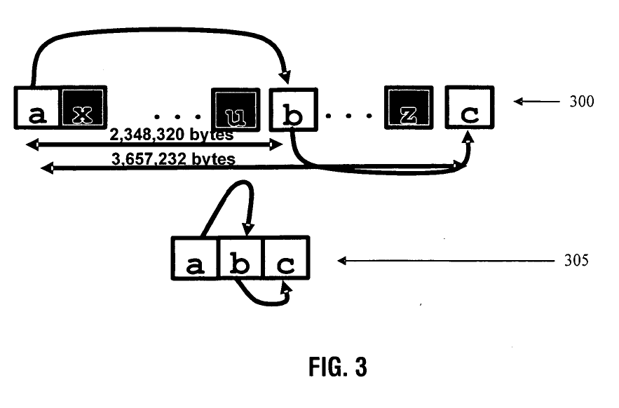

FIG. 2 is a flow chart depicting an embodiment of a pre-fetch operation performed and loads being made from a cache memory after the pre-fetching of the objects from main memory has occurred. The pre-fetching can occur after the objects of the chain have been marked and main memory is reorganized based on the chain of marked objects. With reference to FIG. 3, an embodiment of main memory 300 and reorganized main memory 305 is depicted. Returning to FIG. 2, object marking and pre-fetch instrumentation can be inserted at the definition of references to root objects. The size of the object tree can be estimated by adding together the sizes of the objects in the static object tree. The chain length can be pre-fetched by pre-fetching cache lines starting at the object root and ending at the last byte of the chain or tree.

A chain can start from the object a and end with object c. The pre-fetching of object a at an address a can result in multiple cache lines after a being fetched. For ease of illustration a cache line in this example is 128 bytes, but the cache line can be any number of bytes. An offset of address a can be determined according to the tree size in bytes and the size of a cache line. Data at an original address a can be fetched at block 5, and then multiple cache lines after the original address, for example, at a+128, . . . , a +(floor(treeSize/128)−1)* 128 and a+treeSize−1 can be pre-fetched when a is fetched, also at block 5. The instruction, floor, removes a fraction from the value calculated from the tree size divided by the size of a cache line, leaving an integer value. The pre-fetching instructions at block 5 pre-fetch the data from address a to the last byte of the tree represented by (a+treesize−1). Note the prefetch code of block 5 may be inserted based on instrumentation that identifies root and child objects via markings in accordance with one embodiment, and may be inserted by a compiler in accordance with an embodiment of the present invention.

Thus object A can be the root of the chain and a load of A.F (i.e., field F of object A) can result in a cache miss at block 10. However, by pre-fetching address a to the address of the last byte of the chain or tree, a load of B by A.F, and a load of c by B.F, can result in cache hits, at blocks 15 and 20. Between the blocks 5, 10, 15 and 20 can be additional program code. Thus using dynamic profile-guided prefetching, the prefetch code of block 5 may be inserted at a point well before the data items are needed in execution of the code. This point may be determined based on hardware performance monitoring data, as discussed above.

At block 10, a read of an address plus an offset represented by A.F can be done and the value read at address A.F can be data that is stored in local variable B. The load at block 15 can store in local variable C the contents of memory located at the address stored in B.F. The load at block 20 can store in local variable I the contents of memory located at the address stored in C.F. In the example, the local variable I is loaded by the code using a chain of objects A-B-C in blocks 10 through 20. Pre-fetching the root object and the child objects of the chains into a cache memory can reduce the time that it takes to load integer I.

FIG. 3 shows a main memory 300 that includes objects that may by moved to the cache memory via the pre-fetch operation performed in block 5. Interspersed between these objects is undesired data. In one embodiment, memory storing objects A, B and C can be reorganized so that a pre-fetch of bytes corresponding to the chain or tree size can pre-fetch the chain A-B-C. The reorganization of the memory storing a chain can begin after the root object is marked and the chain or tree is created, and may be performed by a garbage collection process, discussed further below. The reorganized object chain or tree 305 can have the objects in consecutive memory locations.

Loading the physical memory after A can result in objects that are not part of the chain A-B-C being loaded into cache memory and taking space in the cache memory.

Referring now to FIG. 3, shown is a block diagram showing a portion of a main memory storing objects. In some embodiments, a memory 50 can have millions of bytes between two objects in a chain.

For example, object B can be located at an offset of 2,348,320 bytes from object A. Thus, a pre-fetch of object A and the next four cache lines, such as that shown in block 5 of FIG. 2 may result in a cache miss. For example, if a memory had the contents AX . . . UB . . . ZC . . . and A was fetched and the following four cache lines were pre-fetched, object A and object X can be fetched, however objects B and C of the chain are not fetched, as objects B and C are not located in the four cache lines following object A (in the embodiment of FIG. 3) and thus may not be in the cache when accessed if the chain A-B-C was not pre-fetched. Object X as well as other objects located in the four cache lines following object A may be using space in cache memory that can be used more efficiently for other data since X is not part of the chain A-B-C.

Pre-fetching of a reorganized object chain or tree 305 can be done by pre-fetching the root object and the following memory that can be determined by adding together the size of the root object and the child objects of the chain or tree. Pre-fetching a size equal to the size of the objects of the chain or tree added together can allow objects that are members of the chain or tree to be fetched without fetching objects that are not part of the chain or tree.

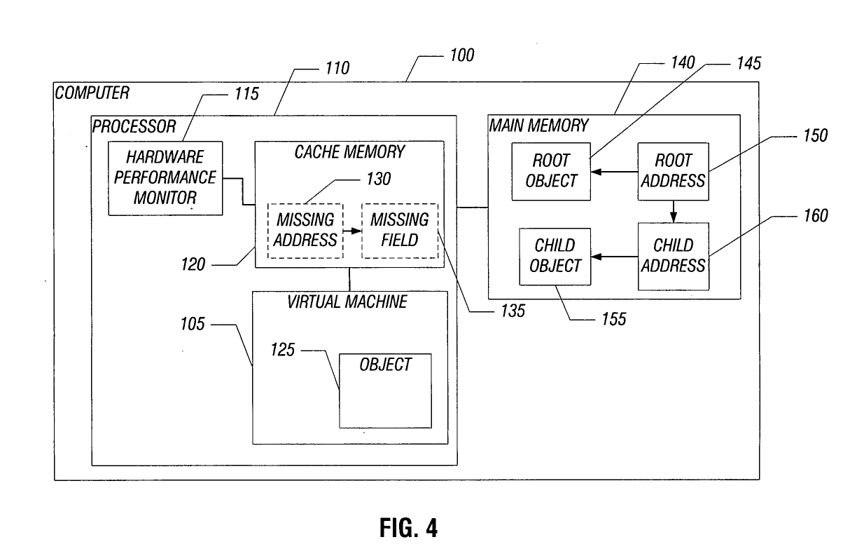

FIG. 4 depicts a computer including a Java virtual machine in accordance with an embodiment. The computer 100 includes a processor 110. The processor 110 can be multiple processors and the processor can include multiple processor cores, although only a single processor core is shown for ease of illustration in FIG. 4. A virtual machine 105 can operate on the processor 110. The virtual machine 105 can execute objects 125. The processor 110 can include a hardware performance monitor 115 coupled to a cache memory 120. The cache memory 120 can include fields of objects referenced by addresses. The processor 110 can be connected to a main memory 140. The main memory can be located outside of the processor 110. The main memory can be a dynamic random access memory, a static random access memory, or another type of memory. The main memory 140 can include objects referred to by addressing, such as a root object 145 referenced by address 150.

The Java virtual machine 105 can execute a program within an object 125. The object 125 can load other objects or fields from other objects. The other objects can be identified by an address in memory. The cache memory 120 can be checked first for the address of the field that is being loaded. If the address of the field is not located within the cache memory, the load address can be considered delinquent. The hardware performance monitor 115 can identify this address as a delinquent address. The main memory 140 can then be accessed to load the field of the object 145 identified by address 150 (for example).

The object 145 at address 150 can be marked in the object header as a delinquent root. The hardware performance monitor 115 can identify other objects with fields that are being loaded. The other objects with fields that are going to be loaded in a chain with root object 145 can be identified by marking in the object header as a delinquent child. For example, root object 145 identified by address 150 can be the beginning of a chain of delinquent objects. The chain can include a child object such as child object 155 identified by child address 160.

Identifying chains of delinquent objects can reduce the cache miss rate, in some embodiments. The chain of objects which include the root object 145 and the child object 155 can be pre-fetched into cache memory 120 when a load for a field 135 identified by address 130 is performed. The root object 145 and the child object 155 can be of different types or of different classes, in some embodiments.

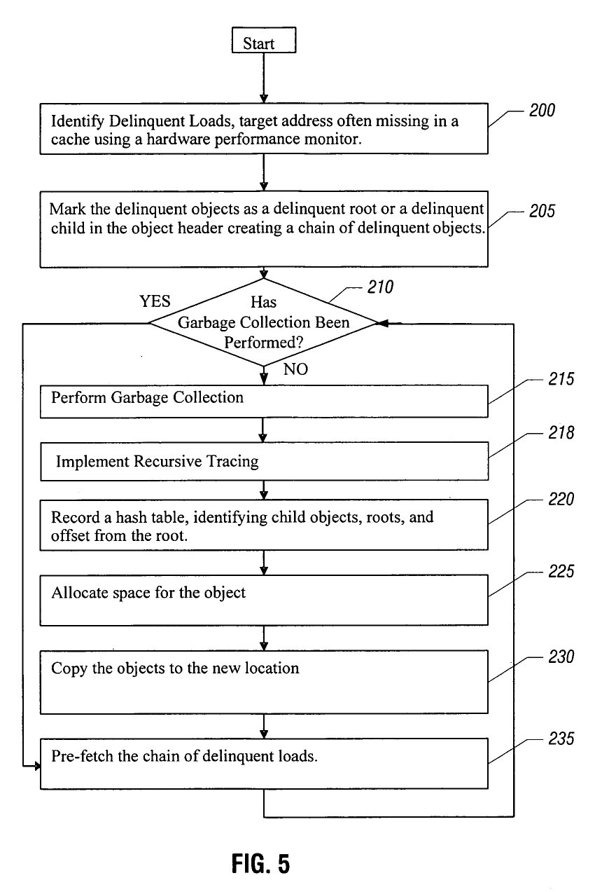

FIG. 5 depicts a flow chart of an embodiment of a method to identify delinquent chains of objects. Target addresses frequently missing in the cache can be identified at block 200 using a hardware performance monitor, for example. The objects loaded by the delinquent loads can be marked at block 205 by instrumentation in the header of those objects as a delinquent root object or a delinquent child object. Identifying delinquent loads at block 200 and marking delinquent objects at block 205 can be repeated for additional delinquent loads.

Still referring to FIG. 5, marked delinquent objects can be used for pre-fetching chains of delinquent objects or for a garbage collection operation. Garbage collection reclaims memory that is no longer in use by tracing all of the objects that are live and reclaiming the space of dead objects. If a garbage collection operation has not been performed at diamond 210 on a chain identified at block 200 and marked at block 205, a garbage collection process can begin at block 215. If a garbage collection operation has been performed at diamond 210 on objects identified at block 200 and marked at block 205 then the chain can be pre-fetched at block 235. Such prefetching thus enables storage of objects in a cache memory prior to their usage via following load operations in a code segment. Accordingly, the expense of cache misses is avoided.

A marking of delinquent chains of objects can be helpful in performing a garbage collection operation. Objects can be moved when garbage collection is performed. The objects can be in half the memory and when the memory is filled the objects are copied to the other half of the memory. The live objects can be copied when the copying is performed. The dead objects, or objects where nothing is pointing to them, can remain at the previous location and not moved or copied to the new location. The garbage collection may begin at block 215. Different of performing garbage collection may be implemented in different embodiments. In one embodiment a so-called mark-sweep-compact garbage collection may be performed. Such a garbage collection may implement an external, whole, heap compaction. In this way, objects that are live can be marked, and these live objects may then be moved to another location in memory, and then the remaining portions of memory outside of this portion can be reused. Child objects can be determined at garbage collection time if the child objects are not marked by the instrumentation.

To perform the garbage collection operation, a marking phase in accordance with such a mark-sweep-compact garbage collection routine can implement recursive tracing (block 218). Specifically, when a root delinquent object is encountered, all connected delinquent child objects that have yet to be claimed by other roots may be recursively traced (block 218). Then, delinquent child objects that have not been claimed by other roots can be marked and a hash table entry for each object can be recorded at block 220. The entry can include for a child, its root, and the future offset from that root. An entry for a root can include the root and the total chain size (e.g., in bytes). At the same time, the children and root objects can be marked as ready to prevent other roots from claiming the children. In one embodiment, such ready marking may be indicated by a ready bit being set in the object header of each of the objects.

Next, during a compaction phase, space can be allocated for a chain when a delinquent ready object is encountered at block 225. More specifically, if the encountered object is the first encountered object from its chain, the space may be allocated. Furthermore, the cache entry for the root may be updated to reflect this change. Then objects can then be copied to a new location, referenced via the hash table at block 230. During the garbage collection, delinquent child, root, and ready bits can be unmarked as the objects are copied to their new location. At the conclusion of copying the objects, the hash table can be cleared (still block 230).

Note that in various embodiments, when compaction is performed (i.e., external compaction), objects may be copied in forward order so that the allocation order of objects is maintained. By copying the chained objects in allocation order, later prefetching that is done on the chain objects can provide for the insertion of the correct objects into a cache memory via a minimal amount of prefetching. Note that if instead compaction were performed in which the relative order of objects was reversed, a prefetch such as that shown above in FIG. 2 may not prefetch the correct data.

Accordingly, at the conclusion of garbage collection, control passes from block 230 to block 235, where a chain of delinquent loads that has had garbage collection performed on it in accordance with the present invention may be prefetched into a cache memory (block 235). Note that the operation taking place at each block 200 through 235 can be repeated for other loads, objects and chains while operations are being performed. For example, other objects can be marked at block 205 while garbage collection is being performed on a chain already identified at block 200 and marked at block 205.

Referring back to FIG. 3, shown is a delinquent object chain. The chain includes the objects A, B, and C. The objects A, B, and C can be located in memory 300. The objects A, B, and C are separated by other objects X, U, and Z. By identifying the chain of delinquent objects A, B, and C, the objects can be copied to another section of memory 305 without other objects such as X, U, and Z located between the locations of A, B, and C in memory. For example, such copying of chain of objects may be performed in a garbage collection process in accordance with an embodiment of the present invention. Accordingly, the chain of objects may be co-located and further may be reallocated in such a manner that the copies remain in allocation order. In this way, next-line prefetching may be used to instrument code to perform minimal prefetching operations to enable chained objects to be prefetched into a cache memory prior to their reference during operation.

Thus, as described above, the chains of ready objects can be copied to the new location in the order the objects were stored in at the previous location. Copying the chains of objects to a new location in an order different than the order the objects existed in the previous location (e.g., by backwards copying) may cause the chains to be pre-fetched incorrectly.

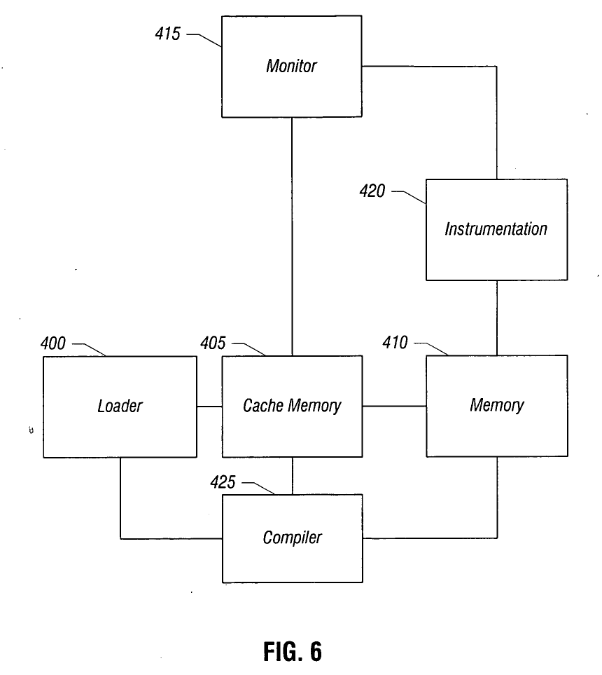

FIG. 6 depicts an apparatus for identifying chains of delinquent objects in accordance with one embodiment of the present invention. A loader 400 can be connected to a cache memory 405. Cache memory 405 can be connected to a memory 410. A monitor 415, which may be a hardware-based performance monitor, can be connected to the cache memory 405 and instrumentation 420. The instrumentation 420 can be connected to the memory 410. A compiler 425 can be connected to the cache memory 405, the memory 410, and the loader 400.

The loader 400 can read from the cache memory 405 for a field at an address. If the address does not exist in the cache memory 405 the main memory 410 can be read by the cache memory 405 and data at the address can be loaded in the cache memory 405. The monitor 415 can identify addresses that are not present in the cache memory 405. The instrumentation 420 can use this address information from the monitor 415 to identify the objects that contain the field located at the address not found in the cache memory 405. The instrumentation 420 can mark at least one bit in the header of such objects. If the loader 400 loads the field at the address the compiler 425 can pre-fetch the chain of delinquent objects from memory 410 and store them in cache memory 405. The loader 400 can load the addresses of the chain from the cache memory 405 after the compiler has pre-fetched the chain, improving performance.

In various embodiments, one or more of loader 400, monitor 415, instrumentation 420, and compiler 425 may be implemented in software, such as a machine-readable medium including instructions to perform such operations.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
identifying an address frequently absent from a cache memory;
marking an object associated with the address in an object oriented program environment to indicate the object as delinquent; and
pre-fetching a chain of objects when the object is loaded from a memory to the cache memory.

2. The method of claim 1, further comprising writing a first bit in a header of the object to mark the object as delinquent and writing a second bit in the header to indicate a relational status of the object.

3. The method of claim 1, including moving the chain of objects to substantially consecutive locations in the memory from disjoint locations in the memory.

4. The method of claim 3, including moving the objects of the chain to a new location in the same order as a previous location.

5. The method of claim 1, including inserting code to perform pre-fetching the chain of objects prior to a load operation for the address frequently absent.

6. The method of claim 1, further comprising marking each object of the chain of objects as root or child.

7. The method of claim 6, further comprising identifying the address via a profile-guided optimization and marking each object via profiling instrumentation.

8. A device comprising:
instrumentation to mark an object including a field absent from a cache memory at least one time by writing at least one bit in a header of the object in an object oriented program environment to indicate the absence; and
a compiler to create a chain of objects to pre-fetch when the object is absent from the cache memory.

9. The device of claim 8, including a garbage collector to move the objects of the chain to consecutive locations in a main memory.

10. The device of claim 8, including a garbage collector to move the objects of the chain to a new location in a memory in an allocation order with respect to the objects.

11. The device of claim 8, wherein the instrumentation is to mark the object as root or child in the header of the object.

12. The device of claim 8, including a monitor to identify the field of the object absent from the cache memory a percentage of time.

13. A system comprising:
a processor to execute an object oriented program;
a monitor to identify an address frequently absent from a first memory;
a dynamic random access memory (DRAM) coupled to the processor to store an object associated with the address;
instrumentation to mark the object to indicate the absence; and
a compiler to create a chain of objects to pre-fetch when the object is absent from the first memory.

14. The system of claim 13, including a garbage collector to move the objects of the chain to consecutive locations in the DRAM.

15. The system of claim 13, including a garbage collector to move the objects of the chain to a new location in the DRAM in the same order as a previous location.

16. The system of claim 13, wherein the instrumentation is to further mark the object as root or child of the chain of objects.

17. The system of claim 16, wherein the instrumentation is to mark a header of the object.

18. An article comprising a machine readable medium storing instructions that when executed cause a system to:
identify an address frequently absent from a cache memory;
mark an object associated with the address in an object oriented program environment; and
pre-fetch a chain of objects when the object is loaded.

19. The article of claim 18, further storing instructions that, when executed cause the system to move the objects of the chain to consecutive locations in a main memory.

20. The article of claim 18, further storing instructions that, when executed cause the system to move the objects of the chain to a new location in the same order as a previous location.

21. The article of claim 18, further storing instructions that, when executed cause the system to mark the object as root or child.

22. The article of claim 18, further storing instructions that, when executed cause the system to mark a header of the object.
